(19) United States
(12) Patent Application Publication
(10) Pub. No.: US 2017/0144884 A1
(43) Pub. Date: May 25, 2017

(54) Dihydrogen Production Process

(71) Applicant: Commissariat a l'Energie Atomique et aux Energies Alternatives, Paris (FR)

(72) Inventors: Thibault Cantat, Issy les Moulineaux (FR); Anis Tlili, Villeurbanne (FR); Clément Chauvier, Paris (FR)

(73) Assignee: Commissariat a l'Energie Atomique et aux Energies Alternatives, Paris (FR)

(21) Appl. No.: 15/323,581

(22) PCT Filed: Jul. 16, 2015
(86) PCT No.: PCT/IB2015/055392

§ 371 Date: Jan. 3, 2017

(30) Foreign Application Priority Data
Jul. 18, 2014 (FR) 14 56949

(51) Int. Cl. C01B 3/22; B01J 31/02; H01M 8/0612; C01C 1/04

(52) U.S. Cl. CPC C01B 3/22; C01C 1/04; B01J 31/0298; B01J 31/0291; B01J 31/0285; H01M 8/0618; C01B 2203/0277; C01B 2203/066; C01B 2203/84; C01B 2203/068; C01B 2203/061; C01B 2203/065; C01B 2203/1041; C01B 2203/1211; B01J 2531/002

(57) ABSTRACT

The present invention relates to a process for producing dihydrogen from formic acid. It also relates to the use of the dihydrogen produced by the process of the invention, in a fuel cell, in a combustion engine, in the production of ammonia and methanol, in oil refining, and in the metallurgy, electronics and food sectors. The invention also relates to an energy production process comprising a step of producing dihydrogen from formic acid by the process according to the invention.

The present invention relates to a process for producing dihydrogen starting from formic acid.

It also relates to the use of the dihydrogen produced by the process of the invention, in a fuel cell, in a combustion engine, in the production of ammonia and methanol, in petroleum refining, and in the metallurgy, electronics and food sectors.

The invention further relates to a method for producing energy, comprising a step of producing dihydrogen from formic acid by the process according to the invention.

Dihydrogen or H₂ is an attractive fuel that is carbon-free and can be used for supplying fuel cells and can thus serve as an alternative to carbon-containing fossil fuels.

Dihydrogen can only perform its role of energy carrier if it can be stored efficiently, at limited cost and in acceptable conditions of safety.

As dihydrogen is a gas that is characterized by a low volumetric energy density (0.010 MJ/L), at atmospheric pressure (1±0.3 atm) and room temperature (20±5° C.), notably compared to diesel (38.6 MJ/L), storage of H₂ in a dense liquid or solid form is therefore necessary to facilitate its transport and distribution. In this context, various methods of storage are being studied. At atmospheric pressure (1±0.3 atm) and room temperature (20±5° C.), a volume of 11 m³ is required to store 1 kg of dihydrogen.

Current storage technologies compress dihydrogen at high pressure (>700 bar) or liquefy it at −253° C. to reach respective densities of 42 and 70 kgH₂/m³. Storage in the form of metal hydrides, such as MgH₂, makes it possible to reach densities of 110 kgH₂/m³. Basically, these methods consume a lot of energy: they may consume up to a third of the energy contained in the gas, and are associated with additional risks (high pressures, metal hydrides that are reactive with respect to water, etc.). For example, a pressure of 700 bar or more presents safety problems. The reactivity of the metal hydrides with respect to water poses problems of stability of the storage material. In fact, after hydrolysis, the metal hydrides, for example MgH₂, are unusable for storing H₂.

Storage of H₂ in the form of formic acid offers many advantages as it makes it possible to reach a good density of dihydrogen (53 kgH₂/m³) at atmospheric pressure (1±0.3 atm) and room temperature (20±5° C.). Moreover, formic acid is of low toxicity and is noncorrosive in a dilute medium, i.e. an aqueous medium containing at most 85 vol % of formic acid relative to the total volume of the medium. Dihydrogen stored in this way is released by a reaction of dehydrogenation of formic acid. As shown in scheme 1, the reaction of dehydrogenation of formic acid requires the use of catalysts for accelerating the release of H₂ and CO₂. The dihydrogen released may be used as fuel.

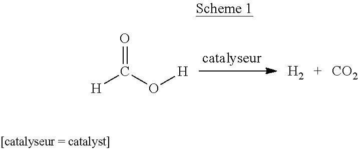

Currently, the catalysts used in reactions of dehydrogenation of formic acid consist of complexes of metals such as ruthenium, platinum, rhodium or nickel, metals that are often expensive and/or toxic. In the context of dehydrogenation of formic acid to H₂ and CO₂, the technical challenge is to develop efficient catalysts that do not have the problems of toxicity, availability and cost generally associated with the use of known metal catalysts, notably catalysts based on precious metals.

The reaction of dehydrogenation of formic acid may also be carried out in a basic medium to improve the performance of the catalyst, for example by adding a sub-stoichiometric amount of triethylamine (Et₃N) as shown in scheme 2 or using an aqueous solution of sodium formate as illustrated in scheme 3:

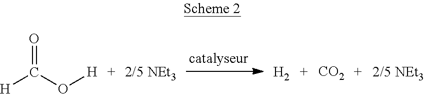

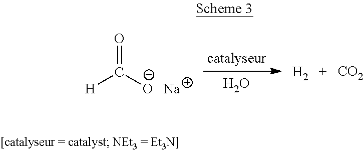

The organic bases and basic additives used conventionally to promote the dehydrogenation of formic acid are described in the review by Beller et al. (H. Junge, A. Boddien, F. Capitta, B. Loges, J. R. Noyes, S. Gladiali, M. Beller, Tetrahedron Lett. 2009, 50, pages 1603-1606).

The known catalysts for promoting the reaction of dehydrogenation of formic acid are based on transition metal complexes or inorganic heterogeneous systems. A recent review (M. Grasemann, G. Laurenczy, Energ. Environ. Sci. 2012, 5, pages 8171-8181) describes the state of the art ENREF 2 and some examples of standard catalysts, which are presented hereunder.

The known homogeneous-phase catalytic systems for promoting the reaction of dehydrogenation of formic acid are transition metal complexes. The first work in this field was carried out by Coffey, who showed that the iridium complex IrH₂Cl(PPh₃)₃ gave turnover frequencies (TOF) of 1187 h⁻¹ at a temperature from 100 to 117° C. (R. S. Coffey, Chem. Commun. 1967, pages 923-924). Using the [Ir(C₅Me₅)(4,4′-dihydroxy-2,2′-bipyridine)] complex, Himeda (Y. Himeda, Green Chem 2009, 11, pages 2018-2022) obtained a turnover frequency or TOF of 3100 h⁻¹ at 60° C.

Beller's group (A. Boddien, B. Loges, H. Junge, F. Gartner, J. R. Noyes, M. Beller, Adv. Synth. Catal. 2009, 351, pages 2517-2520) investigated a large number of molecular complexes of ruthenium for catalyzing the dehydrogenation of formic acid. Among them, a catalyst generated in situ from [RuCl₂(benzene)]₂ and 6 equivalents of 1,2-bis(diphenylphosphino)ethane makes it possible to reach a turnover number or TON of 260 000 after two months of reaction (TOF=900 h⁻¹) for the dehydrogenation of formic acid at 40° C., with N,N-dimethyl-n-hexylamine as basic additive.

Beller, Laurenczy et al. (A. Boddien, D. Mellmann, F. Gartner, R. Jackstell, H. Junge, P. J. Dyson, G. Laurenczy, R. Ludwig, M. Beller, Science, 2011, 333, pages 1733-1736) then studied a series of catalysts based on iron complexes. This research showed that the complex [Fe(BF₄)₂].6H₂O has high catalytic activity in the dehydrogenation of formic acid, leading to a turnover frequency or TOF of 1942 h^{'1} after 3 hours at 40° C.

In 2014, Myers and Berben (T. W. Myers, L. A. Berben, Chem Sci, 2014, 5, pages 2771-2777) developed complexes of aluminum(III) stabilized by bis-imino-pyridine ligands that have an initial maximum TOF of 5200 h⁻for the dehydrogenation of formic acid, carried out at 65° C. in THF, in the presence of triethylamine as additive.

Heterogeneous catalysts have also been described in the literature for promoting the catalytic dehydrogenation of formic acid. These are metallic systems, most often nanoparticles, used in the form of alloys or monometallic systems. This field of research has been the subject of recent reviews, available in the literature (S. Enthaler, J. von Langermann, T. Schmidt, Energ. Environ. Sci. 2010, 3, pages 1207-1217; M. Grasemann, G. Laurenczy, Energ. Environ. Sci. 2012, 5, pages 8171-8181).

This state of the art reveals that all of the catalysts known at present for promoting the production of dihydrogen from formic acid are based on metallic systems, most often based on noble metals.

There is therefore a real need for a catalyst for production of dihydrogen from formic acid that is effective (capable of increasing the rate of conversion of formic acid to H₂ and CO₂), inexpensive and/or of low toxicity compared to the known catalysts.

In particular, there is a real need for a catalyst, as defined above, that does not contain:

alkaline-earth metals of group IIA of the periodic table (such as magnesium and calcium);

metals of group IIIA, namely aluminum, gallium, indium and thallium;

transition metals of group IB to VIIIB of the periodic table (such as nickel, iron, cobalt, zinc, copper, rhodium, ruthenium, platinum, palladium, iridium);

rare earths whose atomic number is between 57 and 71 (such as lanthanum, cerium, praseodymium, neodymium); or

actinides whose atomic number is between 89 and 103 (such as thorium, uranium).

The present invention has precisely the aim of meeting these needs, by providing a process for producing dihydrogen from formic acid, characterized in that formic acid is brought into contact
with at least one catalyst selected from:
   (i) Lewis acids, said Lewis acids being selected from organic or inorganic boron compounds, organic or inorganic silicon compounds, oxoniums, carbocations, organic or inorganic germanium compounds and organic or inorganic tin compounds; and optionally
with at least one compound selected from
   (ii) an organic base selected from nitrogen-containing organic bases, phosphorus-containing organic bases, carbon-containing bases, and oxygen-containing organic bases; and/or
   (iii) a halide salt.

The process of the invention makes it possible to produce dihydrogen with a large choice of catalysts.

The catalysts used in the process of the invention offer the advantage that they do not have the toxicity problems generally observed for metal catalysts as well as the problems of cost associated with the use of precious metals.

In fact, in the process of the invention, the catalyst employed does not contain:

alkaline-earth metals of group IIA of the periodic table selected from magnesium and calcium;

metals of group IIIA selected from aluminum, gallium, indium and thallium;

transition metals of group IB to VIIIB of the periodic table selected from nickel, iron, cobalt, zinc, copper, rhodium, ruthenium, platinum, palladium and iridium;

rare earths whose atomic number is between 57 and 71 selected from lanthanum, cerium, praseodymium and neodymium; or

actinides whose atomic number is between 89 and 103 selected from thorium and uranium.

Furthermore, production of dihydrogen from formic acid by the process of the invention may also be accompanied by the concomitant production of CO₂. In this case, dihydrogen will be mixed with carbon dioxide. This mixture may be used as it is or the dihydrogen and carbon dioxide can be separated by the methods known by a person skilled in the art, for example H₂/CO₂ separation by adsorption of the CO₂ on ethanolamines or by cryogenic separation.

The CO₂ thus formed may be used/recycled in the process of the invention as inerting gas or may be recovered to be transformed into various chemical compounds, for example formic acid by the methods known by a person skilled in the art, for example those described by Morris, A. J., Meyer, G. J., Fujita, E., Accounts Chem Res 2009, 42, 1983.

Catalyst, in the sense of the invention, means any compound capable of modifying, notably increasing, the rate of the chemical reaction in which it participates, and which is regenerated at the end of the reaction. This definition includes both catalysts, i.e. compounds that exert their catalytic activity without having to undergo any modification or conversion, and compounds (also called precatalysts) that are added to the reaction mixture, where they are converted into a catalyst.

In the sense of the invention, a co-catalyst is a compound that is not a catalyst, but which, in association with a catalyst, allows the catalytic activity of said catalyst to be improved.

In the context of the invention, the turnover number (TON) and the turnover frequency (TOF) of the catalyst are defined as follows:

$$T O N = \frac{{n}_{0} ( HCOOH ) - {n}_{fin} ( HCOOH )}{{n}_{0} ( HCOOH )} \times \frac{100}{catalyst charge , mol \%}$$

$$T O F = T O N \times \frac{1}{reaction time , hours}$$

where n₀(HCOOH) corresponds to the amount of substance of formic acid, i.e. the number of moles of formic acid at the start of the reaction and n_{fin}(HCOOH) corresponds to the amount of substance of formic acid, i.e. the number of moles of formic acid, at the end of the reaction. The higher the TON and TOF values, the more efficient the catalyst.

In the sense of the present invention, “alkyl” means a linear, branched or cyclic carbon-containing radical, saturated, optionally substituted, comprising 1 to 12 carbon atoms. As saturated, linear or branched alkyl, we may mention for example the methyl, ethyl, propyl, butyl, pentyl, hexyl, octyl, nonyl, decyl, undecyl, dodecanyl radicals and their branched isomers. As cyclic alkyl, we may mention the cyclopropyl, cyclobutyl, cyclopentyl, cyclohexyl, bicyclo[2,1,1] hexyl, bicyclo[2,2,1] heptyl radicals. As unsaturated cyclic alkyls, we may mention for example cyclopentenyl, cyclohexenyl.

“Alkenyl” or “alkynyl” means an unsaturated linear, branched or cyclic carbon-containing radical, optionally substituted, said unsaturated carbon-containing radical comprising 1 to 12 carbon atoms comprising at least one double bond (alkenyl) or triple bond (alkynyl). Thus, we may mention, for example, the ethylenyl, propylenyl, butenyl, pentenyl, hexenyl, acetylenyl, propynyl, butynyl, pentynyl, hexynyl radicals and their branched isomers.

The alkyl, alkenyl and alkynyl groups, in the sense of the invention, may optionally be substituted with one or more hydroxyl groups; one or more alkoxy groups;

one or more siloxy groups; one or more halogen atoms selected from the fluorine, chlorine, bromine and iodine atoms; one or more nitro groups (—NO₂); one or more nitrile groups (—CN); one or more aryl groups, with the alkoxy and aryl groups as defined in the context of the present invention.

The term “aryl” generally denotes a cyclic aromatic substituent comprising 6 to 20 carbon atoms. In the context of the invention the aryl group may be mono- or polycyclic. As a guide, we may mention the phenyl, benzyl and naphthyl groups. The aryl group may optionally be substituted with one or more hydroxyl groups, one or more alkoxy groups, one or more “siloxy” groups, one or more halogen atoms selected from the fluorine, chlorine, bromine and iodine atoms, one or more nitro groups (—NO₂), one or more nitrile groups (—CN), one or more alkyl groups, with the alkoxy and alkyl groups as defined in the context of the present invention.

The term “heteroaryl” generally denotes a mono- or polycyclic aromatic substituent comprising 5 to 10 ring members including at least 2 carbon atoms, and at least one heteroatom selected from nitrogen, oxygen, boron, silicon, phosphorus or sulfur. The heteroaryl group may be mono- or polycyclic. As a guide, we may mention the furyl, benzofuranyl, pyrrolyl, indolyl, isoindolyl, azaindolyl, thiophenyl, benzothiophenyl, pyridyl, quinolinyl, isoquinolyl, imidazolyl, benzimidazolyl, pyrazolyl, oxazolyl, isoxazolyl, benzoxazolyl, thiazolyl, benzothiazolyl, isothiazolyl, pyridazinyl, pyrimidilyl, pyrazinyl, triazinyl, cinnolinyl, phthalazinyl, quinazolinyl groups. The heteroaryl group may optionally be substituted with one or more hydroxyl groups, one or more alkoxy groups, one or more halogen atoms selected from the fluorine, chlorine, bromine and iodine atoms, one or more nitro groups (—NO₂), one or more nitrile groups (—CN), one or more aryl groups, one or more alkyl groups, with the alkyl, alkoxy and aryl groups as defined in the context of the present invention.

The term “heterocycle” generally denotes a mono- or polycyclic substituent, comprising 5 to 10 ring members, saturated or unsaturated, containing from 1 to 4 heteroatoms selected independently of one another from nitrogen, oxygen, boron, silicon, phosphorus or sulfur. As a guide, we may mention borolane, borole, borinane, 9-borabicyclo[3.3.1]nonane (9-BBN), 1,3,2-benzodioxaborole (catecholborane or catBH), pinacholborane (pinBH), the morpholinyl, piperidinyl, piperazinyl, pyrrolidinyl, imidazolidinyl, imidazolinyl, pyrazolidinyl, tetrahydrofuranyl, tetrahydropyranyl, thianyl, oxazolidinyl, isoxazolidinyl, thiazolidinyl, isothiazolidinyl substituents. The heterocycle may optionally be substituted with one or more hydroxyl groups, one or more alkoxy groups, one or more aryl groups, one or more halogen atoms selected from the fluorine, chlorine, bromine and iodine atoms, one or more nitro groups (—NO₂), one or more nitrile groups (—CN), one or more alkyl groups, with the alkyl, alkoxy and aryl groups as defined in the context of the present invention.

The term “alkoxy” denotes an alkyl, alkenyl and alkynyl group, as defined above, bound by an oxygen atom (—O-alkyl, O-alkenyl, O-alkynyl).

“Amino” group means a group of formula —NR⁷R⁸, in which:

R⁷ and R⁸ represent, independently of one another, a hydrogen atom, an alkyl group, an alkenyl group, an alkynyl group, an aryl group, a heteroaryl group, a heterocycle, a silyl group, a siloxy group, with the alkyl, alkenyl, alkynyl, aryl, heteroaryl, heterocycle, silyl, siloxy groups as defined in the context of the present invention; or

R⁷ and R⁸, taken together with the nitrogen atom to which they are bound, form a heterocycle optionally substituted with one or more hydroxyl groups; one or more alkyl groups; one or more alkoxy groups; one or more halogen atoms selected from the fluorine, chlorine, bromine and iodine atoms; one or more nitro groups (—NO₂); one or more nitrile groups (—CN); one or more aryl groups; with the alkyl, alkoxy and aryl groups as defined in the context of the present invention.

Halogen atom means an atom selected from the fluorine, chlorine, bromine and iodine atoms.

“Siloxy” group means a silyl group, as defined below, bound by an oxygen atom (—O—Si(X)₃) with X as defined below.

“Silyl” group means a group of formula [—Si(X)₃] in which each X, independently of one another, is selected from a hydrogen atom; one or more halogen atoms selected from the fluorine, chlorine, bromine or iodine atoms; one or more alkyl groups; one or more alkoxy groups; one or more amino groups; one or more aryl groups; one or more siloxy groups; with the alkyl, alkoxy, aryl and siloxy groups as defined in the context of the present invention.

In the process of the invention, the catalyst is (i) a Lewis acid, selected from:
organic or inorganic boron compounds selected from organoboranes, haloboranes, alkoxyboranes, borinium cations, borenium cations, boronium cations, said organic or inorganic boron compounds being selected advantageously from BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN⁺I⁻, Me-TBD-BBN⁺CF₃SO₃⁻, (TDB-BBN)₂, TBD-BBN-CO₂, TBD-BBN-BBN, [TBDH⁺, BBN(OCHO)₂⁻], [Et₃NH⁺, Cy₂B(OCHO)₂⁻];
organic or inorganic silicon compounds selected from organosilanes, halosilanes, alkoxysilanes, silylium cations of formula (R¹R²R³)Si⁺ with R¹, R², R³, independently of one another, representing a hydrogen atom, an alkyl group, an alkoxy group, an amino group, an aryl group, said alkyl, amino, alkoxy and aryl groups optionally being substituted, said organic or inorganic silicon compounds advantageously being selected from SiCl₄, Me₃SiCl, Et₃Si⁺ and Me₃Si⁺;
divalent or tetravalent organic or inorganic germanium compounds selected from organogermanes, halogermanes, alkoxygermanes, germanium cations of formula (R⁹R10R¹¹)Ge⁺ with R⁹, R¹⁰, R¹¹, independently of one another, representing a hydrogen atom, an alkyl group, an alkoxy group, an amino group, an aryl group, said alkyl, amino, alkoxy and aryl groups optionally being substituted, said organic or inorganic germanium compounds being selected advantageously from GeCl₂, GeBr₂, GeCl₄, Ge(OEt₂)₄, Me₃GeCl, Me₂ClGe⁺, Et₃Ge⁺ and Me₃Ge⁺;
organic or inorganic tin compounds with oxidation state +IV or +II selected from derivatives of stannous chloride, cations of formula R²⁰Sn⁺ with R²⁰ representing a hydrogen atom, an alkyl group, an alkoxy group, an amino group, an aryl group, said alkyl, amino, alkoxy and aryl groups optionally being substituted, organostannanes, halostannanes, alkoxystannanes, stannic cations of formula (R¹²R¹³R¹⁴)Sn⁺ with R¹², R¹³, R¹⁴, independently of one another, representing a hydrogen atom, an alkyl group, an alkoxy group, an amino group, an aryl group, said alkyl, amino, alkoxy and aryl groups optionally being substituted, said organic or inorganic tin compounds being selected advantageously from SnCl₂, SnCl₄, nBu₂SnCl₂, Cy₃SnCl, Bu₃SnH, tBu₂SnCl₂, nBuSnCl₃, Me₂SnCl, SnBu₄, tetraisopropoxystannane, tetrakis(acetyloxy)stannane, Me₃SnCl, Et₃Sn⁺ and Me₃Sn⁺;
oxoniums of formula (R¹⁵R¹⁶R¹⁷)O⁺ with R¹⁵, R¹⁶, R¹⁷, independently of one another, representing a hydrogen atom, an alkyl group, an alkoxy group, an amino group, an aryl group, said alkyl, amino, alkoxy and aryl groups optionally being substituted; said oxoniums being selected advantageously from (CH₃)₃O⁺ and (CH₃CH₂)₃O⁺;
carbocations of formula (R⁴R⁵R⁶)C⁺ with R⁴, R⁵, R⁶, independently of one another, representing a hydrogen atom, an alkyl group, an alkenyl group, an aryl group, an alkoxy group, an amino group, a silyl group, a siloxy group and a halogen atom, said alkyl, alkenyl, amino, alkoxy and aryl groups optionally being substituted; said carbocations being selected advantageously from the trityl cation ((C₆H₅)₃C⁺), tropylium (C₇H₇)⁺, the benzyl cation (C₆H₅CH₂⁺), the allyl cation (CH₃—CH⁺—CH═CH₂), methylium (CH₃⁺) and cyclopropylium (C₃H₅⁺).

It should be noted that the anionic counterion of the aforementioned silylium cations, oxoniums, carbocations, stannic cations and germanium cations is, advantageously, a halide selected from F⁻, Br⁻ and I⁻, or an anion selected from BF₄⁻, SbF₆⁻, B(C₆F₅)₄⁻, B(C₆H₅)₄⁻, CF₃SO₃⁻ or TfO⁻ and PF₆⁻.

Preferably, the catalyst is (i) a Lewis acid, selected from:
organic or inorganic boron compounds selected from the organoboranes, haloboranes, alkoxyboranes, borinium cations, borenium cations, boronium cations, said organic or inorganic boron compounds being selected advantageously from BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN⁺ I⁻, Me-TBD-BBN⁺CF₃SO₃⁻, (TDB-BBN)₂, TBD-BBN-CO₂, TBD-BBN-BBN, [TBDH⁺, BBN(OCHO)₂⁻], and [Et₃NH⁺, Cy₂B(OCHO)₂⁻]; and
divalent or tetravalent organic or inorganic germanium compounds selected from organogermanes, halogermanes, alkoxygermanes, germanium cations of formula (R⁹R¹⁰R¹¹)Ge⁺ with R⁹, R¹⁰, R¹¹, independently of one another, representing a hydrogen atom, an alkyl group, an alkoxy group, an amino group, an aryl group, said alkyl, amino, alkoxy and aryl groups optionally being substituted, said organic or inorganic germanium compounds being selected advantageously from GeCl₂, GeBr₂, GeCl₄, Ge(OEt₂)₄, Me₃GeCl, Me₂ClGe⁺, Et₃Ge⁺ and Me₃Ge⁺; and
organic or inorganic tin compounds with oxidation state +IV or +II selected from derivatives of stannous chloride, cations of formula R²⁰Sn⁺ with R²⁰ representing a hydrogen atom, an alkyl group, an alkoxy group, an amino group, an aryl group, said alkyl, amino, alkoxy and aryl groups optionally being substituted, organostannanes, halostannanes, alkoxystannanes, stannic cations of formula (R¹²R¹³R¹⁴)Sn³⁰ with R¹², R¹³, R¹⁴, independently of one another, representing a hydrogen atom, an alkyl group, an alkoxy group, an amino group, an aryl group, said alkyl, amino, alkoxy and aryl groups optionally being substituted, said organic or inorganic tin compounds being selected advantageously from SnCl₂, SnCl₄, nBu₂SnCl₂, Cy₃SnCl, Bu₃SnH, tBu₂SnCl₂, nBuSnCl₃, Me₂SnCl, SnBu₄, tetraisopropoxystannane, tetrakis(acetyloxy)stannane, Me₃SnCl, Et₃Sn⁺ and Me₃Sn⁺.

The anionic counterion of the aforementioned germanium and stannic and stannous cations is, advantageously, a halide selected from F⁻, Cl⁻, Br⁻ and or an anion selected from BF₄⁻, SbF₆⁻, B(C₆F₅)₄⁻, B(C₆H₅)₄⁻, CF₃SO₃⁻ or TfO⁻ and PF₆⁻.

According to a particular embodiment, the process for producing dihydrogen from formic acid is characterized in that formic acid is brought into contact: with at least one catalyst

(i) said catalyst being a Lewis acid, selected from
organic or inorganic boron compounds selected from BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN⁺I⁻, Me-TBD-BBN⁺CF₃SO₃⁻, (TDB-BBN)₂, TBD-BBN-CO₂, TBD-BBN-BBN, [TBDH⁺, BBN(OCHO)₂⁻], [Et₃NH⁺, Cy₂B(OCHO)₂⁻];
organic or inorganic silicon compounds selected from SiCl₄, Me₃SiCl, Et₃Si⁺and Me₃Si⁺;
divalent or tetravalent organic or inorganic germanium compounds selected from GeCl₂, GeBr₂, GeCl₄, Ge(OEt₂)₄, Me₃GeCl, Me₂ClGe⁺, Et₃Ge⁺ and Me₃Ge⁺;
organic or inorganic tin compounds selected from SnCl₂, SnCl₄, nBu₂SnCl₂, Cy₃SnCl, Bu₃SnH, tBu₂SnCl₂, nBuSnCl₃, Me₂SnCl, SnBu₄, tetraisopropoxystannane, tetrakis(acetyloxy)stannane, Me₃SnCl, Et₃Sn⁺and Me₃Sn⁺;
oxoniums selected from (CH₃)₃O⁺ and (CH₃CH₂)₃O⁺;
carbocations selected from the trityl cation ((C₆H₅)₃C⁺), tropylium (C₇F1₇)⁺, the benzyl cation (C₆H₅CH₂⁺), allyl cation (CH₃—CH⁺—CH═CH₂), methylium (CH₃⁺) and cyclopropylium (C₃H₅⁺);
with the anionic counterion of the silylium cations, oxoniums, carbocations, stannic cations and germanium cations being a halide selected from F³¹ , Cl⁻, Br⁻ and I⁻, or an anion selected from BF₄⁻, SbF₆⁻, B(C₆H₅)₄⁻, B(C₆H₅)₄⁻, CF₃SO₃⁻ or TfO⁻ and PF₆⁻;
with at least one compound selected from
   (ii) an organic base selected from nitrogen-containing organic bases, phosphorus-containing organic bases, carbon-containing bases, and oxygen-containing organic bases; and/or
   (iii) a halide salt.

Among the organic boron catalysts, as indicated in scheme 4 below, the catalyst (TBD-BBN)₂ may result from the dimerization of TBD-BBN; TBD-BBN-CO₂ corresponds to an adduct between TBD-BBN and CO₂ and TBD-BBN-BBN corresponds to an adduct between TBD-BBN and 9-BBN.

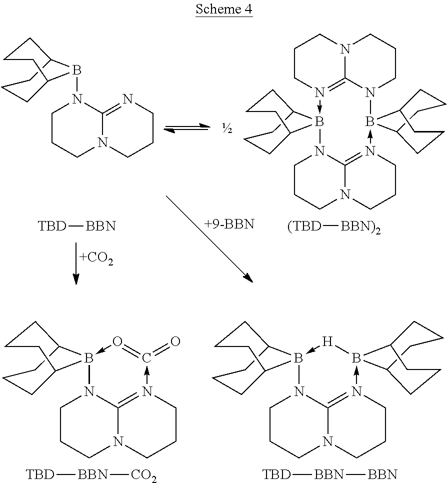

Me-TBD-BBN⁺I⁻, (TBD-BBN)₂, TBD-BBN-CO₂ and TBD-BBN-BBN may be obtained, for example, according to the protocols described below in the examples. Me-TBD-BBN⁺CF₃SO₃⁻ as well as Me-TBD-BBN⁺X⁻ in which X⁻ is selected from fluorine, chlorine and bromine may also be prepared by replacing the reactant 9-iodo-9-borabicyclo[3.3.1]nonane with 9-borabicyclo[3.3.1]nonyltrifluoromethanesulfonate, 9-fluoro-9-borabicyclo[3.3.1]nonane, 9-chloro-9-borabicyclo[3.3.1]nonane or 9-bromo-9-borabicyclo[3.3.1]nonane in the protocol for synthesis of Me-TBD-BBN⁺ I⁻ described hereunder.

The aforementioned carbocations are commercially available or may easily be synthesized by a person skilled in the art by various methods of synthesis, for example: the cation pool method, the internal redox method, the method using a leaving group, methods using Lewis or Brønsted acids. These methods are described in the following references: R. R. Naredla and D. A. Klumpp, Chem. Rev. 2013, 113, pages 6905-6948; M. Saunders and H. A. Jimenez-Vazquez, Chem. Rev. 1991, 91, pages 375-397.

Preferably, (i) the catalyst is a Lewis acid selected from
a derivative of formula R₂BX where R is a saturated linear, branched or cyclic alkyl group, optionally substituted, comprising 1 to 12 carbon atoms, and X is selected from Cl⁻, Br⁻, I⁻, an alkoxide radical such as methoxide —OMe or ethoxide —OEt, OTf, NTf₂ and H;
BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN⁺I⁻, Me-TBD-BBN⁺CF₃SO₃⁻, (TDB-BBN)₂, TBD-BBN-CO₂, TBD-BBN-BBN, [TBDH⁺, BBN(OCHO)₂⁻], [Et₃NH⁺, Cy₂B(OCHO)₂⁻];
SnCl₂, SnCl₄, nBu₂SnCl₂, Cy₃SnCl, Bu₃SnH, tBu₂SnCl₂, nBuSnCl₃, Me₂SnCl, SnBu₄, tetraisopropoxystannane, tetrakis(acetyloxy)stannane, Me₃SnCl, Et₃Sn⁺and Me₃Sn⁺;
with the anionic counterion of the stannic and stannous cations being a noncoordinating anion selected from BF₄⁻, SbF₆⁻, B(C₆F₅)₄⁻, B(C₆H₅)₄⁻, CF₃SO₃⁻ or TfO⁻ and PF₆⁻, or a halide selected from F⁻, Cl⁻, Br⁻ and I⁻.

It should be noted that no ionic liquid is employed, in particular as catalyst, in the process of the invention.

According to a variant of the process of the invention, formic acid is brought into contact with (i) a Lewis acid as catalyst and (ii) an organic base as co-catalyst.

The organic base (ii) may be selected from:
nitrogen-containing organic bases, which are advantageously secondary or tertiary amines selected from triazabicyclodecene (TBD); N-methyltriazabicyclodecene (Me-TBD), 1,8-diazabicyclo[5.4.0]undec-7-ene (DBU), trimethylamine, triethylamine, piperidine, 4-dimethylaminopyridine (DMAP), 1,4-diazabicyclo[2.2.2]octane (DABCO), proline, phenylalanine, a thiazolium salt, N-diisopropylethylamine (DIPEA or DIEA);
phosphorus-containing organic bases, which are advantageously alkyl or aryl phosphines, for example selected from triphenylphosphine, 2,2′-bis(diphenylphosphino)-1,1′-binaphthyl (BINAP), triisopropylphosphine, 1,2-bis(diphenylphosphino)ethane (dppe), tricyclohexylphosphine (PCy₃); the alkyl and aryl phosphonates, for example selected from diphenylphosphate, triphenylphosphate (TPP), tri(isopropylphenyl)phosphate (TIPP), cresyldiphenyl phosphate (CDP), tricresylphosphate (TCP); the alkyl and aryl phosphates, for example selected from di-n-butylphosphate (DBP), tris-(2-ethylhexyl)-phosphate, triethyl phosphate; the alkyl and aryl phosphinites and phosphonites, for example selected from methyldiphenylphosphinite and methyldiphenylphosphonite, the aza-phosphines, for example selected from 2,8,9-triisopropyl-2,5,8,9-tetraaza-1-phosphabicyclo[3.3.3]undecane (BV^{Me}) and 2,8,9-triisobutyl-2,5,8,9-tetraaza-1-phosphabicyclo[3.3.3]undecane (BV^{iBu});
carbon-containing bases for which protonation takes place on a carbon atom, selected advantageously from the N-heterocyclic carbenes derived from an imidazolium salt, said carbenes being, for example, selected from the salts of 1,3-bis(2,6-diisopropylphenyl)-1H-imidazol-3-ium (also called IPr), 1,3-bis(2,6-diisopropylphenyl)-4,5-dihydro-1H-imidazol-3-ium (also called s-IPr), 1,3-bis(2,4,6-trimethylphenyl)-1H-imidazol-3-ium (also called IMes), 1,3-bis(2,4,6-trimethylphenyl)-4,5-dihydro-1H-imidazol-3-ium (also s-IMes), 4,5-dichloro-1,3-bis(2,6-diisopropylphenyl)-1H-imidazol-3-ium (also called C1₂-IPr), 1,3-di-tert-butyl-1H-imidazol-3-ium (also called ItBu), 1,3-di-tert-butyl-4,5-dihydro-1H-imidazol-3-ium (also called s-ItBu), said salts being in the form of chloride salts, for example; and
oxygen-containing bases selected from, for example, hydrogen peroxide; benzoyl peroxide; pyridine oxide (PyO), N-methylmorpholine oxide and 1-λ¹-oxidanyl-2,2,6,6-tetramethylpiperidine.

Examples of N-heterocyclic carbenes are shown below:

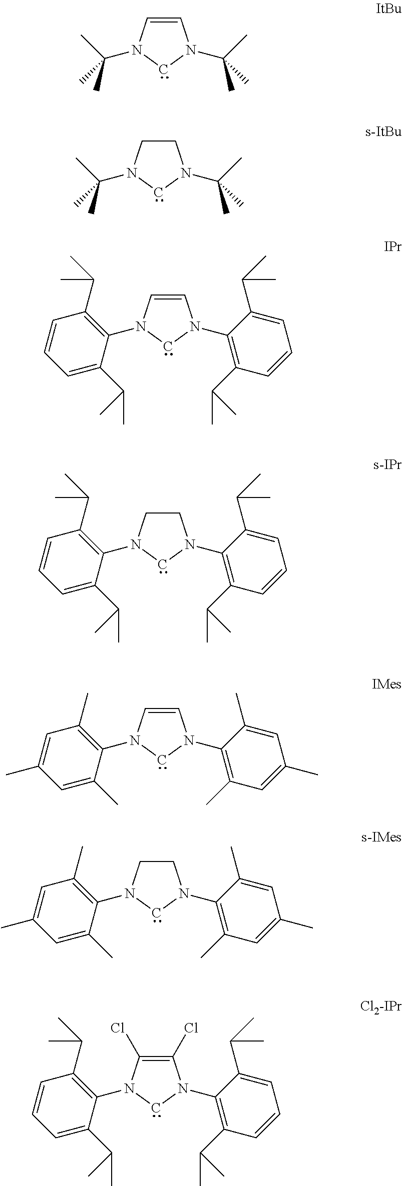

Some of the abbreviations used are:

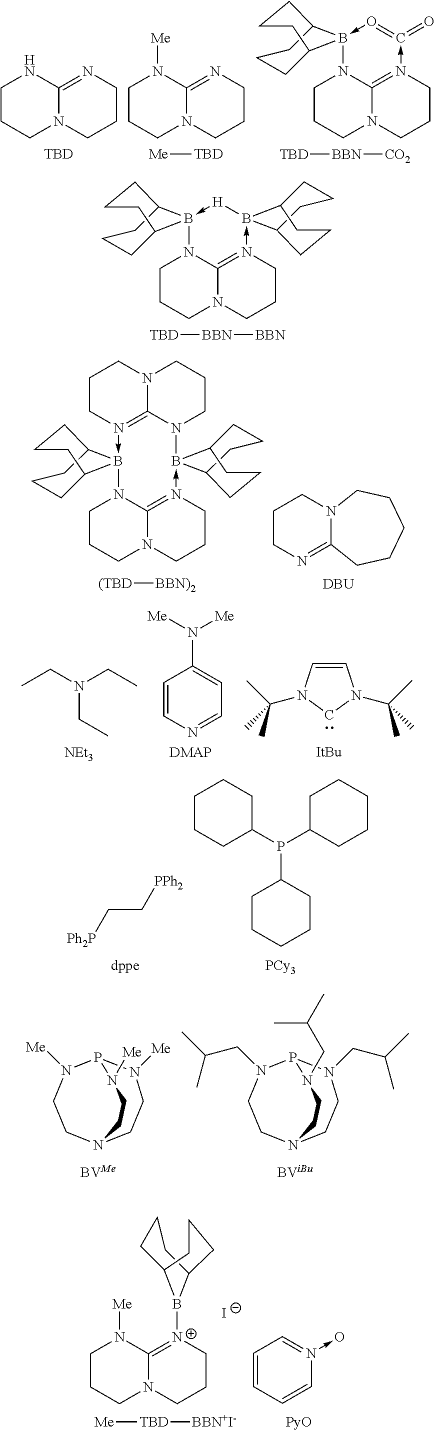

The compound 1-λ¹-oxidanyl-2,2,6,6-tetramethylpiperidine is shown below

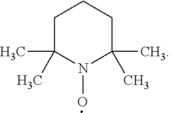

Preferably, the organic base is a nitrogen-containing organic base selected from triazabicyclodecene (TBD); N-methyltriazabicyclodecene (Me-TBD), 1,8-diazabicyclo[5.4.0]undec-7-ene (DBU), trimethylamine, triethylamine, piperidine, 4-dimethylaminopyridine (DMAP), 1,4-diazabicyclo[2.2.2]octane (DABCO), proline, phenylalanine, a thiazolium salt, N-diisopropylethylamine (DIPEA or DIEA).

According to another variant of the process of the invention, formic acid is brought into contact with (i) a Lewis acid as catalyst and (iii) a halide salt as co-catalyst.

The halide salt (iii) may be selected from the chloride, bromide, iodide and fluoride salts, said halide salts being selected, for example, from NaF, NaCl, NaBr, NaI, KCl, LiCl, [(n-Bu₄)N⁺,F⁻], [(n-Bu₄)N⁺,Cl⁻], [(n-Bu₄)N⁺,Br⁻], [(n-Bu₄)N⁺,I⁻], [PPh₄⁺,F⁻], [PPh₄⁺,Cl⁻], [PPh₄⁺,Br⁻] and [PPh₄⁺,I⁻].

According to a particular embodiment of the invention, the process for producing dihydrogen from formic acid is characterized in that formic acid is brought into contact: with at least one catalyst

(i) said catalyst being a Lewis acid, selected from
a derivative of formula R₂BX where R is a saturated linear, branched or cyclic alkyl group, optionally substituted, comprising 1 to 12 carbon atoms, and X is selected from the halides Cl⁻, Br⁻, I⁻, the alkoxides such as methoxide —OMe or ethoxide —OEt, OTf, NTf₂ or else H;
BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN⁺I⁻, Me-TBD-BBN⁺CF₃SO₃⁻, (TDB-BBN)₂, TBD-BBN-CO₂, TBD-BBN-BBN, [TBDH⁺, BBN(OCHO )₂⁻], [Et₃NH⁺, Cy₂B(OCHO)₂⁻];
SnCl₂, SnCl₄, nBu₂SnCl₂, Cy₃SnCl, Bu₃SnH, tBu₂SnCl₂, nBuSnCl₃, Me₂SnCl, SnBu₄, tetraisopropoxystannane, tetrakis(acetyloxy)stannane, Me₃SnCl, Et₃Sn⁺and Me₃Sn⁺;
with the anionic counterion of the stannic and stannous cations being a noncoordinating anion selected from BF₄⁻, SbF₆⁻, B(C₆F₅)₄⁻, B(C₆H₅)₄⁻, CF₃SO₃⁻ or TfO⁻ and PF₆⁻, or a halide selected from F⁻, CF⁻, Br⁻ and I⁻;
with at least one compound selected from
   (ii) nitrogen-containing organic bases selected from triazabicyclodecene (TBD); N-methyltriazabicyclodecene (Me-TBD), 1,8-diazabicyclo[5.4.0]undec-7-ene (DBU), trimethylamine, triethylamine, piperidine, 4-dimethylaminopyridine (DMAP), 1,4-diazabicyclo[2.2.2]octane (DABCO), proline, phenylalanine, a thiazolium salt, N-diisopropylethylamine (DIPEA or DIEA); and/or

(iii) a halide salt selected from NaF, NaCl, NaBr, Nal, KCl, LiCl, [(n-Bu₄)N⁺,F⁻], [(n-Bu₄)N⁺,Cl⁻], [(n-Bu₄)N⁺,Br⁻], [(n-Bu₄)N⁺,I⁻], [PPh₄⁺,F⁻], [PPh₄⁺,I⁻], [PPh₄⁺,Br⁻] and [PPh₄⁺,I⁻].

The dihydrogen production process according to the invention may thus employ:
at least (i) a Lewis acid as catalyst(s),
at least (i) a Lewis acid mixed with at least one co-catalyst, which may be (ii) an organic base or (iii) a halide salt, or else
at least (i) a Lewis acid mixed with a mixture of co-catalysts (ii) and (iii).

In the process of the invention, (i) the Lewis acid may be mixed with (ii) an organic base and/or (iii) a halide salt, as defined above. As examples of mixtures of (i) and (ii), we may mention the mixtures chlorodicyclohexylborane/Me-TBD, B-chlorocatecholborane/DBU, chlorodicyclohexylborane/BV^{Me} or 9-iodo-9-borabicyclo[3.3.1]nonane/Et₃N.

In the process of the invention, (i) the Lewis acid may be joined by a covalent bond to (ii) an organic base and/or (iii) a halide salt. As an example of a molecule in which (i) is joined by a covalent bond to (iii), we may mention TBD-BBN-BBN and TBD-BBN-CO₂.

The catalysts may, if necessary, be immobilized on heterogeneous supports, for example in order to ensure easy separation and/or recycling of said catalyst. Said heterogeneous supports may be selected from supports based on silica gel or plastics, for example polystyrene; carbon-containing supports selected from carbon nanotubes; silicon carbide; alumina; or magnesium chloride (MgCl₂).

As already stated, production of dihydrogen from formic acid by the process of the invention may be accompanied by the concomitant production of carbon dioxide. In this case, the mixture of dihydrogen and carbon dioxide may be used as it is or the dihydrogen and carbon dioxide may be separated by the methods known by a person skilled in the art, for example H₂/CO₂ separation by adsorption of the CO₂ on ethanolamines or cryogenic separation.

The dihydrogen produced may therefore be used directly in fuel cells or in an internal-combustion engine. In the case when the dihydrogen and the carbon dioxide are separated, the carbon dioxide may be used:

in the process as inerting gas, it may be transformed into formic acid, formamide, methanal, methanol and methane by known methods,

in the food industry, by creating, for example, a protective atmosphere for controlling the proliferation of microorganisms (insect larvae, bacteria, fungi, etc.) present in foodstuffs, such as cereals or sandwich bread, by depriving them of oxygen, or else

for producing chemical compounds, for example fuels, plastics, medicinal products, detergents, high-tonnage chemicals, traditionally obtained by petrochemical processes.

Besides the catalyst (i) and optionally the compounds (ii) and/or (iii), the process of the invention may optionally be carried out in the presence of at least one basic additive. Said additive may be an organic or inorganic base having a pKa greater than that of formic acid, i.e. a pKa greater than 3.7 to allow generation of formate ions HCOO⁻ from formic acid, thus contributing to acceleration of the reaction rate and therefore production of dihydrogen. Moreover, said basic additive may also help to trap in solution, in the form of carbonate or hydrogen carbonate ions for example, all or part of the CO₂ produced, thus making it possible to obtain pure dihydrogen or a gas mixture enriched with H₂. Said basic additive may be selected, for example, from

organic amines selected from triethylamine, piperidine and 4-dimethylaminopyridine (DMAP),

ammonia and ammonium,

carbon-containing inorganic bases selected from the carbonate salts CO₃²⁻, the hydrogen carbonate salts HCO₃⁻, said carbonate salts CO₃²⁻ and hydrogen carbonate salts HCO₃⁻ being selected from CaCO₃ and NaHCO₃,

oxygen-containing inorganic bases selected from the hydroxide salts HO⁻, said hydroxide salts being selected from KOH and NaOH.

When formic acid is brought into contact with at least one catalyst (i) and optionally compounds (ii) and/or (iii), in the presence of a basic additive, the amount of basic additive used may be from 0.1 to 1 molar equivalent, inclusive, relative to the number of moles of formic acid.

Production of dihydrogen according to the process of the invention may take place at a pressure of CO₂, H₂, dinitrogen (N₂), argon or a mixture of at least two of these gases.

Thus, production of dihydrogen from formic acid by the process of the invention may take place under the pressure of the gases formed (H₂ or H₂+CO₂ mixture), under pressure of inert gases (N₂ and/or argon), or under a reduced pressure by collecting the gases formed in a low-pressure system, for example in a buret.

The process of the invention may then take place at a pressure between 0.1 and 75 bar, preferably between 0.1 and 30 bar, more preferably between 0.1 and 10 bar, inclusive.

The reaction of formic acid with the catalyst (i) and optionally compounds (ii) and/or (iii), and if necessary in the presence of a basic additive as defined above, may be carried out at a temperature between 15 and 150° C., preferably between 15 and 130° C., inclusive.

The reaction time depends on the degree of conversion of formic acid. The reaction is advantageously maintained until there is complete conversion of formic acid. The reaction time may be from 5 minutes to 200 hours, preferably from 10 minutes to 48 hours, inclusive.

The process for producing dihydrogen from formic acid according to the invention may also take place in a solvent or a mixture of at least two solvents selected from:

water;

alcohols, preferably ethanol or ethylene glycol;

ethers, preferably diethyl ether, or THF;

hydrocarbons, preferably benzene, or toluene;

nitrogen-containing solvents, preferably pyridine, or acetonitrile;

sulfoxides, preferably dimethylsulfoxide;

alkyl halides, preferably chloroform, or methylene chloride;

a supercritical fluid, preferably supercritical CO₂.

The various reactants used in the process of the invention, notably formic acid, (pre)catalysts, co-catalysts, basic additives, are in general commercial compounds or may be prepared by the methods already described in the literature and known by a person skilled in the art.

The amount of catalyst used in the process of the invention is from 0.0001 to 1 molar equivalent, preferably from 0.001 to 1 molar equivalent, more preferably from 0.001 to 0.5 molar equivalent, inclusive, relative to the number of moles of formic acid.

The operating conditions given above apply to all the embodiments of the process of the invention.

The dihydrogen obtained by the process of the invention may be used notably for producing ammonia and methanol, and petroleum refining. It may also be used in the metallurgy and electronics sectors, in pharmacy and in the treatment of food products.

When used in a fuel cell or an internal-combustion engine, the dihydrogen produced by the process of the invention may combine with oxygen of the air to produce electricity, with water as the only effluent. Dihydrogen therefore has considerable potential for supplying clean energy and guaranteeing security of supply.

The invention also relates to the use of the dihydrogen produced by the process of the invention in a fuel cell, in a combustion engine, in the production of ammonia and methanol, in petroleum refining, and in the metallurgy, electronics and food sectors.

The invention further relates to a process for producing energy, characterized in that it comprises a step of producing dihydrogen from formic acid by the process according to the invention.

Other advantages and features of the present invention will become clear on reading the following nonlimiting examples, given for purposes of illustration.

### EXAMPLES

The catalytic reaction of dehydrogenation of formic acid, presented in scheme 5, may be carried out according to the following experimental protocol:
1. Under an inert atmosphere of argon or dinitrogen, in a glove box, formic acid, the precatalyst (from 1 to 0.001 equivalent) and, optionally, the solvent and the basic additive are put in a Schlenk tube, which is then sealed with a J. Young tap. The order of introducing the reactants is not important.
2. The Schlenk is then heated at a temperature between 25 and 140° C. until there is complete conversion of formic acid (from 5 minutes to 150 hours of reaction).
3. The gases emitted may be collected during the reaction by a system of burets or else a system connected to a device using the gases that are emitted, such as a PEMFC fuel cell. Alternatively, the gases may be stored in the sealed reaction chamber if the latter is able to withstand the gas pressure generated.

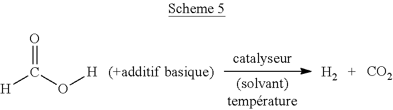

| | |
|---|---|
| additif basique | basic additive |
| catalyseur | catalyst |
| (solvant) | (solvent) |
| température | temperature |

Various catalysts, additives, solvents and temperatures were tested for the reaction.

The catalysts Me-TBD-BBN⁺I⁻, (TDB-BBN)₂, TBD-BBN-CO₂, TBD-BBN-BBN, [TBDH⁺, BBN(OCHO)₂⁻] and [Et₃NH⁺, Cy₂B(OCHO)₂⁻] were prepared according to the following protocols:

Synthesis of (TBD-BBN)₂

A 20-mL flask equipped with a magnetized bar and sealed with a J. Young stopper is charged with TBD (163.1 mg, 1.17 mmol, 1 eq), the dimer (9-BBN)₂ (143.0 mg, 0.59 mmol, 0.5 eq) and tetrahydrofuran (3.5 mL). The flask is sealed and the solution is stirred for one hour at 70° C. The reaction mixture is cooled to room temperature and then the solid is filtered on a frit and washed with diethyl ether. A white solid is recovered and is dried under reduced pressure, obtaining the product (TBD-BBN)₂ in a yield of 75% (194.9 mg).

Synthesis of TBD-BBN-CO₂

A 20-mL flask equipped with a magnetized bar and sealed with a J. Young stopper is charged with (TBD-BBN)₂ (71.0 mg, 0.14 mmol) and tetrahydrofuran (4 mL). The reaction mixture is put under an atmosphere of CO₂ (1 bar). The flask is sealed and the solution is stirred for 75 minutes at 100° C. The white solid in the reaction mixture gradually dissolves during heating. The reaction mixture is cooled to room temperature (about 20° C.) and then the solvent is evaporated under reduced pressure in order to recover TBD-BBN-C₂ in the form of a white solid in quantitative yield (84.0 mg).

Synthesis of TBD-BBN-BBN

A 20-mL flask equipped with a magnetized bar and sealed with a J. Young stopper is charged with (TBD-BBN)₂ (100.0 mg, 0.19 mmol, 1 eq), the dimer (9-BBN)₂ (51.0 mg, 0.21 mmol, 1.1 eq) and tetrahydrofuran (5 mL). The flask is sealed and the solution is stirred for 150 minutes at 100° C. The white solid in the reaction mixture gradually dissolves during heating. The reaction mixture is cooled to room temperature and then the solvent is partially evaporated from the reaction mixture to about 0.5 mL. During evaporation of the solvent, a white solid appears. The solid is filtered on a frit and washed with cold diethyl ether (−40° C.). The solid is recovered and is dried under reduced pressure, obtaining the product TBD-BBN-BBN in a yield of 76% (110.5 mg).

Synthesis of Me-TBD-BBN⁺I⁻

A 20-mL flask equipped with a magnetized bar and sealed with a J. Young stopper is charged with Me-TBD (53.1 mg, 0.35 mmol, 1 eq) and tetrahydrofuran (3.5 mL). The solution is stirred and a 1M solution of 9-iodo-9-borabicyclo[3.3.1]nonane in hexane (350 μL, 0.35 mmol, 1 eq) is added to the reaction mixture. A white precipitate forms immediately after adding 9-iodo-9-borabicyclo[3.3.1]nonane solution. The flask is sealed and the solution is stirred for 30 minutes at room temperature (about 20° C.). The solid is filtered on a frit and washed with diethyl ether. The solid is recovered and is dried under reduced pressure, obtaining the product Me-TBD-BBN⁺I⁻ in a yield of 81% (112.0 mg).
¹H NMR (200 MHz, CD₂Cl₂): δ 4.13 (m, 1H), 3.95 (m, 1H), 3.75 (m, 2H), 3.48 (m, 4H), 3.10 (s, 3H), 2.49-1.18 (m, 18H) ppm.
^{—}C NMR (50 MHz, CD₂Cl₂): δ 158.7, 48.7, 48.4, 43.4, 41.2, 36.1, 35.5, 31.5, 30.9, 25.9, 24.9, 20.9, 20.4 ppm.
¹¹B NMR (64 MHz, CD₂Cl₂): δ 57.2 ppm.
Elemental analysis: calc. for C₁₆H₂₉BIN₃ (M 401.14 g.mol⁻¹): C: 47.91, H: 7.29, N: 10.48. Found: C: 48.26, H 6.96; N 11.63.
   ORTEP View of Me-TBD-BBN⁺I⁻ Obtained by X-ray Diffraction.

Synthesis of [TBDH⁺, BBN(OCHO)₂⁻].

A 25-mL flask equipped with a magnetized bar and a J-Young tap is charged with the dimer 9-BBN (342 mg, 1.4 mmol, 0.5 equiv.) and 5 mL of toluene. The suspension obtained is stirred until the solid has dissolved completely and then formic acid (258 mg, 211 μL, 5.6 mmol, 2 equiv) is added using a syringe, followed by TBD (390 mg, 2.8 mmol, 1 equiv) in one go. Considerable evolution of hydrogen gas is observed. The reaction is then stirred for 2 h at room temperature and then pentane (5 mL) is added. A white solid precipitates, and the latter is then recovered by filtration and washed with pentane (3×2 mL). The white solid thus recovered is dried under reduced pressure, obtaining [TBDH⁺, BBN(OCHO)₂⁻] (930 mg) in a yield of 93%. The latter can be recrystallized from a saturated toluene solution.
¹H NMR (200 MHz, CD₃CN) δ 8.40 (s, 2H), 6.94 (bs, 2H), 3.23 (dd, J=11.3, 5.3 Hz, 8H), 2.06-1.21 (m, 16H), 0.72 (bs, 2H).
¹³C NMR (50 MHz, CD₃CN) δ 167.23, 152.07, 47.43, 38.74, 32.07, 25.62, 21.16.
¹¹B NMR (64 MHz, CD₃CN) δ 8.87.
Elemental analysis: calc. (%) for C₁₇H₃₀BN₃O₄ (351.25 g.mol⁻¹): C 58.13, H 8.61, N 11.96; found: C 58.12, H 8.58 N 12.16.
   ORTEP View of [TBDH⁺, BBN(OCHO)₂⁻] Obtained by X-Ray Diffraction.

Synthesis of [Et₃NH⁺, Cy₂B(OCHO)₂⁻]

Dicyclohexylborane Cy₂BH is synthesized according to a procedure described in the literature and is used without special purification.

A 25-mL flask, equipped with a magnetized bar and a J-Young tap, is charged with Cy₂BH (481 mg, 2.7 mmol, 1 equiv.) and 5 mL of toluene. The suspension obtained is stirred until the solid has dissolved completely, and then formic acid (204 4, 5.4 mmol, 2 equiv) is added using a syringe, followed by Et₃N (377 4, 2.7 mmol, 1 equiv) in one go. Considerable evolution of hydrogen gas is observed. The reaction is then stirred for 2 h at room temperature and then the solvent is evaporated to dryness, leaving a very viscous oil. After multiple additions of pentane and trituration of the oil in hexane, the oil crystallizes and a white solid is obtained; the latter is then recovered by filtration and washed with pentane (3 33 2 mL) and ether (3×2 mL). The white solid thus recovered is dried under reduced pressure, obtaining [Et₃NH⁺, Cy₂B(OCHO)₂⁻] (901 mg) in a yield of 90%. ¹H NMR (200 MHz, CD₃CN) δ 8.77 (s, 1H, NH), 8.29 (s, 2H, HC(O)O), 3.13 (t, J=7.2 Hz, 6H), 1.65 (d, J=4.3 Hz, 4H), 1.50 (d, J=12.8 Hz, 4H), 1.24 (t, J=7.3 Hz, 9H), 1.12 (d, J=7.6 Hz, 4H), 1.01-0.73 (m, 4H), 0.48 (tt, J=12.0 Hz, 2H, CH-B) ppm.
¹³C NMR (50 MHz, CD₃CN) δ 166.43, 47.39, 29.38, 28.50, 9.06 ppm.
¹¹B NMR (64 MHz, CD₃CN) δ 11.17 ppm.
Elemental analysis: calc. (%) for C₂₀H₄₀BNO₄ (369.30 g.mol⁻¹): C 65.04, H 10.92, N 3.79; found: C 63.05, H 11.03, N 3.41.

A set of results is presented below in Table 1, giving examples of production of dihydrogen from formic acid. In all the tests carried out, CO₂ is also obtained. The amount of formic acid used in all the tests is 0.2 mmol. Various catalysts were also tested.

TABLE 1

| | Amount of | | | | Reaction | Conversion to | | |
|---|---|---|---|---|---|---|---|---|
| | catalyst | | Additive | Temperature | time | H₂ and CO₂ | TON | |
| Catalyst | (mol %) | Solvent | (mmol) | (° C.) | (hours) | (%) | (TOF, h⁻¹) | |
| [Me-TBD- | 10 | THF | — | 150 | 120 | 100 | 10 | (0.08) |
| BBN⁺I⁻] | | | | | | | | |
| [Me-TBD- | 5 | THF | — | 130 | 67 | 100 | 20 | (0.3) |
| BBN⁺I⁻] | | | | | | | | |
| [Me-TBD- | 2 | THF | — | 130 | 67 | 66 | 33 | (0.5) |
| BBN⁺I⁻] | | | | | | | | |
| [Me-TBD- | 2 | THF | — | 130 | 91 | 92 | 46 | (0.5) |
| BBN⁺I⁻] | | | | | | | | |
| [DBU- | 5 | THF | — | 130 | 63 | 95 | 19 | (0.3) |
| BBN⁺, I⁻] | | | | | | | | |
| BBN—I | 5 | THF | MTBD | 130 | 18 | 30 | 7 | (0.38) |
| | | | (0.02) | | | | | |
| PPh₃ + | — | THF | — | 130 | 96 | 68 | 7 | (0.07) |
| BBNI | | | | | | | | |
| [Me-TBD- | 5 | THF | Et₃N | 130 | 25 | 52 | 10.4 | (0.41) |
| BBN⁺I⁻] | | | (0.08) | | | | | |
| [Me-TBD- | 5 | THF | Et₃N | 130 | 43 | 100 | 20 | (0.46) |
| BBN⁺, I⁻] | | | (0.08) | | | | | |
| [Me-TBD- | 5 | MeCN | Et₃N | 130 | 19 | 89 | 18 | (0.94) |
| BBN⁺, I⁻] | | | (0.08) | | | | | |
| [DBU- | 5 | THF | Et₃N | 130 | 40 | 47 | 9 | (0.23) |
| BBN⁺, I⁻] | | | (0.08) | | | | | |
| tBu3P + | 5 | THF | Et₃N | 130 | 22 | 20 | 4 | (0.18) |
| BBN—I⁻ | | | (0.08) | | | | | |
| BBN—I | 5 | THF | Et₃N | 130 | 19 | 48 | 9.6 | (0.51) |
| | | | (0.08) | | | | | |
| BBN—I | 5 | MeCN | Et₃N | 130 | 19 | 84 | 16.8 | (0.88) |
| | | | (0.08) | | | | | |
| BBN—I | 5 | MeCN | Et₃N | 120 | 19 | 18 | 3.6 | (0.19) |
| | | | (0.08) | | | | | |
| BBN-OTf | 5 | MeCN | Et₃N | 130 | 19 | 59 | 11.8 | (0.62) |
| | | | (0.08) | | | | | |
| BBN—OMe | 5 | MeCN | Et₃N | 130 | 19 | 88 | 17.5 | (0.92) |
| | | | (0.08) | | | | | |
| [TBDH⁺•BBN | 5 | MeCN | Et₃N | 130 | 19 | 67 | 13.4 | (0.71) |
| (OCHO)₂⁻] | | | (0.08) | | | | | |
| [TBDH⁺•BBN | 2 | MeCN | Et₃N | 130 | 19 | 59 | 23.6 | (1.24) |
| (OCHO)₂⁻] | | | (0.08) | | | | | |
| BBN—H | 5 | MeCN | Et₃N | 130 | 19 | 52 | 10.4 | (0.55) |
| | | | (0.08) | | | | | |
| Cy₂B—I | 10 | MeCN | Et₃N | 130 | 4.5 | >99 | 10 | (2.2) |
| | | | (0.08) | | | | | |
| Cy₂B—I | 5 | MeCN | Et₃N | 130 | 19 | >99 | 20 | (0.52) |
| | | | (0.08) | | | | | |
| Cy₂B—I | 1 | MeCN | Et₃N | 130 | 19 | 79 | 79 | (4.16) |
| | | | (0.08) | | | | | |
| Cy₂B—I | 1 | MeCN | Et₃N | 130 | 40 | 100 | 100 | (2.5) |
| | | | (0.08) | | | | | |
| Cy₂B—Cl | 5 | MeCN | Et₃N | 130 | 19 | >99 | 20 | (0.52) |
| | | | (0.08) | | | | | |
| Cy₂B-OTf | 5 | MeCN | Et₃N | 130 | 19 | >99 | 20 | (0.52) |
| | | | (0.08) | | | | | |
| (Et₃NH⁺, Cy₂B | 5 | MeCN | Et₃N | 130 | 8 | >99 | 20 | (2.50) |
| (OCHO)₂⁻] | | | (0.08) | | | | | |
| (Et₃NH⁺, Cy₂B | 2.5 | MeCN | Et₃N | 130 | 9 | >99 | 40 | (4.44) |
| (OCHO)₂⁻] | | | (0.08) | | | | | |
| [Et₃NH⁺, Cy₂B | 1 | MeCN | Et₃N | 130 | 19 | 78 | 78 | (4.11) |
| (OCHO)₂⁻] | | | (0.08) | | | | | |
| [Et₃NH⁺, Cy₂B | 1 | MeCN | Et₃N | 130 | 26 | 100 | 100 | (3.84) |
| (OCHO)₂⁻] | | | (0.08) | | | | | |
| BCl₃ | 5 | MeCN | Et₃N | 130 | 19 | 44 | 8.8 | (0.46) |
| | | | (0.08) | | | | | |
| nBu₂SnCl₂ | 5 | MeCN | Et₃N | 130 | 18 | 60 | 12 | (0.67) |
| | | | (0.08) | | | | | |
| nBu₂SnCl₂ | 5 | MeCN | Et₃N | 330 | 25 | 82 | 16.4 | (0.66) |
| | | | (0.08) | | | | | |
| Cy₃SnCl | 5 | MeCN | Et₃N | 130 | 45 | 35 | 7 | (0.16) |
| | | | (0.08) | | | | | |
| nBu₂SnH | 5 | MeCN | Et₃N | 130 | 45 | 29 | 5.8 | (0.13) |
| | | | (0.08) | | | | | |
| tBuSnCl₂ | 5 | MeCN | Et₃N | 130 | 45 | 95 | 19 | (0.42) |
| | | | (0.08) | | | | | |
| nBuSnCl₃ | 5 | MeCN | Et₃N | 130 | 15 | 40 | 8 | (0.53) |
| | | | (0.08) | | | | | |
| nBuSnCl₃ | 5 | MeCN | Et₃N | 130 | 25 | 66 | 13.2 | (0.53) |
| | | | (0.08) | | | | | |
| Me₂SnCl | 5 | MeCN | Et₃N | 130 | 15 | 34 | 6.8 | (0.45) |
| | | | (0.08) | | | | | |
| Me₂SnCl | 5 | MeCN | Et₃N | 130 | 25 | 41 | 8.2 | (0.33) |
| | | | (0.08) | | | | | |
| SnCl₂ | 5 | MeCN | Et₃N | 130 | 16 | 83 | 16.6 | (1.03) |
| | | | (0.08) | | | | | |

The catalysts [TBDH⁺, BBN(OCHO)₂⁻] and [Et₃NH⁺, Cy₂B(OCHO)₂⁻] may be represented as follows:

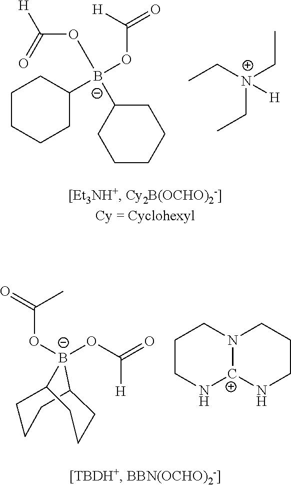

As already noted, formic acid may be converted to H₂, or to a mixture of H₂ and CO₂, which can be separated by the methods known by a person skilled in the art, for example H₂/CO₂ separation by adsorption of the CO₂ on ethanolamines or by cryogenic separation.

When the process of the invention results in a mixture of dihydrogen and carbon dioxide, the amount of each gas in the mixture can be determined, for example, by collecting the gases in a buret and analyzing the composition of the mixture by gas chromatography. These techniques are techniques that are commonly used in this field and are familiar to a person skilled in the art. In the above table, the yields in conversion of formic acid shown correspond to the yields in conversion of formic acid to an equimolar mixture of H₂ and CO₂.

At 130° C., the maximum TOF observed is 4.44 h⁻¹ and the maximum TON measured is 100 (with [Et₃NH⁺,Cy₂B(OCHO)₂⁻]⁻ as catalyst). These results demonstrate, for the first time, that catalysts that do not employ group IIA alkaline-earth metals, group IIIA metals, transition metals of group IB to VIIIB, rare earths or actinides may be used for promoting the production of dihydrogen from formic acid.

1. A process fey of producing dihydrogen from formic acid, wherein formic acid is brought into contact:
with at least one catalyst
(i) said catalyst being a Lewis acid selected from
organic or inorganic boron compounds selected from BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN⁺I⁻, Me-TBD-BBN⁺CF₃SO₃⁻, (TDB-BBN)₂, TBD-BBN-CO₂, TBD-BBN-BBN, [TBDH⁺ BBN(OCHO)₂⁻], [Et₃NH⁺Cy₂B(OCHO)₂⁻];
organic or inorganic silicon compounds selected from SiCl₄, Me₃SiCl, Et₃Si⁺and Me₃Si⁺;
divalent or tetravalent organic or inorganic germanium compounds selected from GeCl₂, GeBr₂, GeCl₄, Ge(OEt₂)_{4,} Me₃GeCl, Me₂ClGe⁺, Et₃Ge⁺and Me₃Ge⁺;
organic or inorganic tin compounds with oxidation state +IV or +II selected from SnCl₂, SnCl₄, nBu₂SnCl₂, Cy₃SnCl, Bu₃SnH, tBu₂SnCl₂, nBuSnCl₃, Me₂SnCl, SnBu₄, tetraisopropoxystannane, tetrakis(acetyloxy)stannane, Me₃SnCl, Et₃Sn⁺and Me₃Sn⁺;
oxoniums selected from (CH₃)₃O⁺and (CH₃CH₂)₃O⁺;
carbocations selected from the trityl cation ((C₆H₅)₃C⁺), tropylium (C₇H₇)⁺, the benzyl cation (C₆H₅CH₂⁺), allyl cation (CH₃—CH⁺—CH═CH₂), methylium (CH₃⁺) and cyclopropylium (C₃H₅⁺); with the anionic counterion of the silylium cations, oxoniums, carbocations, stannic cations and germanium cations being a halide selected from F⁻, Cl⁻, Br⁻ and I⁻, or an anion selected from BF₄⁻, SbF₆⁻, B(C₆F₅)₄⁻, B(C₆H₅)₄⁻, CF₃SO₃⁻ or TfO⁻ and P F₆⁻; with at least one compound selected from
(ii) an organic base selected from nitrogen-containing organic bases, phosphorus-containing organic bases, carbon-containing bases, and oxygen-containing organic bases; and/or
(iii) a halide salt.

2. The process as claimed in claim 1, wherein (i) the Lewis acid is selected from
a derivative of formula R₂BX where R is a saturated linear, branched or cyclic alkyl group, optionally substituted, comprising 1 to 12 carbon atoms, and X is selected from the halides Cl⁻, Br⁻, I⁻, the alkoxides such as methoxide —OMe or ethoxide —OEt, OTf, NTf₂ or else H;
BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN⁺I⁻, Me-TBD-BBN⁺CF₃SO₃^{'}, (TDB-BBN)₂, TBD-BBN-CO₂, TBD-BBN-BBN, [TBDH⁺, BBN(OCHO)₂⁻], [Et₃NH⁺, Cy₂B(OCHO)₂⁻];
SnCl₂, SnCl₄, nBu₂SnCl₂, Cy₃SnCl, Bu₃SnH, tBu₂SnCl₂, nBuSnCl₃, Me₂SnCl, SnBu₄, tetraisopropoxystannane, tetrakis(acetyloxy)stannane, Me₃SnCl, Et₃Sn⁺ and Me₃Sn⁺;
with the anionic counterion of the stannic and stannous cations being a noncoordinating anion selected from BF₄⁻, SbF₆⁻, B(C₆F₅)₄⁻, B(C₆H₅)₄⁻, CF₃SO₃⁻ or TfO⁻ and PF₆⁻, or a halide selected from F⁻, Cr⁻, Br⁻ and I⁻.

3. The process as claimed in claim 1, wherein (ii) the organic base is selected from:
- nitrogen-containing organic bases which are secondary or tertiary amines selected from triazabicyclodecene (TBD); N-methyltriazabicyclodecene (Me-TBD), 1,8-diazabicyclo[5.4.0]undec-7-ene (DBU), trimethylamine, triethylamine, piperidine, 4-dimethylaminopyridine (DMAP), 1,4-diazabicyclo[2.2.2]octane (DABCO), proline, phenylalanine, a thiazolium salt, N-diisopropylethylamine (DIPEA or DIEA);
phosphorus-containing organic bases which are alkyl or aryl phosphines selected from triphenylphosphine, 2,2′-bis(diphenylphosphino)-1,1′-binaphthyl (BINAP), triisopropylphosphine, 1,2-bis(diphenylphosphino)ethane (dppe), tricyclohexylphosphine (PCy₃); alkyl and aryl phosphonates selected from diphenylphosphate, triphenylphosphate (TPP), tri(isopropylphenyl)phosphate (TIPP), cresyldiphenyl phosphate (CDP), tricresylphosphate (TCP); alkyl and aryl phosphates selected from di-n-butylphosphate (DBP), tris-(2-ethylhexyl)phosphate, triethyl phosphate; alkyl and aryl phosphinites and phosphonites selected from methyldiphenylphosphinite and methyldiphenylphosphonite, the aza-phosphines selected from 2,8,9-thisopropyl-2,5,8,9-tetraaza-1-phosphabicyclo[3.3.3]undecane (BV^{Me}) and 2,8,9-thisobutyl-2,5,8,9-tetraaza-1-phosphabicyclo[3.3.3]undecane (BV^{IB}I;
carbon-containing bases selected from N-heterocyclic carbenes derived from an imidazolium salt, said carbenes being selected from the salts of 1,3-bis(2,6-diisopropylphenyl)-1H-imidazol-3-ium, 1,3-bis(2,6-diisopropylphenyl)-4,5-dihydro-1H-imidazol-3-ium, 1,3-bis(2,4,6-trimethylphenyl)-1H-imidazol-3-ium, 1,3-bis(2,4,6-trimethylphenyl)-4,5-dihydro-1H-imidazol-3-ium, 4,5-dichloro-1,3-bis(2,6-diisopropylphenyl)-1H-imidazol-3-ium, 1,3 di tert butyl 1H 1,3-di-tert-butyl-4,5-dihydro-1H-imidazol-3-ium, said salts being in the form of chloride salts;
oxygen-containing bases selected from hydrogen peroxide; benzoyl peroxide; pyridine oxide (PyO), N-methylmorpholine oxide and 1-A¹-oxidanyl-2,2,6,6-tetramethylpiperidine.

4. The process as claimed in claim 1, wherein (ii) the organic base is a nitrogen-containing organic base selected from triazabicyclodecene (TBD); N-methyltriazabicyclodecene (Me-TBD), 1,8-diazabicyclo[5.4.0]undec-7-ene (DBU), trimethylamine, triethylamine, piperidine, 4-dimethylaminopyridine (DMAP), 1,4-diazabicyclo[2.2.2]octane (DABCO), proline, phenylalanine, a thiazolium salt, N-diisopropylethylamine (DIPEA or DIEA).

5. The process as claimed in claim 1, wherein (iii) the halide salt is selected from the chloride, bromide, iodide and fluoride salts, said halide salts being selected from NaF, NaCl, NaBr, Nal, KCl, LiCl, [(n-Bu₄)N⁺,F⁻], [(n-Bu₄)N⁺, Cl⁻], [(n-Bu₄)N⁺,Br⁻], [(n-Bu₄)N⁺,I⁻], [PPh₄⁺,F⁻], [PPh₄⁺,Cl⁻], [PPh₄⁺,Br⁻] and [PPh₄⁺,I⁻].

6. The process as claimed in claim 1, wherein formic acid is brought into contact with
(i) a Lewis acid as defined in one of claim 1 or 2 selected from:
a derivative of formula R₂BX where R is a saturated linear, branched or cyclic alkyl group, optionally substituted, comprising 1 to 12 carbon atoms, and X is selected from the halides Cl⁻, Br⁻, I⁻, the alkoxides such as methoxide OMe or ethoxide OEt, OTf, NTf₂ or else H;
BF₃, BF₃(Et₂O), BCl₃, diphenyl hydroborane, dicyclohexyl hydroborane, chlorodicyclohexylborane, 9-iodo-9-borabicyclo[3.3.1]nonane (BBNI), B-chlorocatecholborane, B(C₆F₅)₃, B-methoxy-9-borabicyclo[3.3.1]nonane (B-methoxy-9-BBN), B-benzyl-9-borabicyclo[3.3.1]nonane, Me-TBD-BBN³⁰I⁻, Me-TBD-BBN⁺CF₃SO₃⁻, (TDB-BBN)₂, TBD-BBN-CO₂, TBD-BBN-BBN, [TBDH⁺, BBN(OCHO)₂⁻], [Et₃NH⁺, Cy₂B(OCHO)₂⁻];
SnCl₂, SnCl₄, nBu₂SnCl₂, Cy₃SnCl, Bu₃SnH, tBu₂SnCl₂, nBuSnCl₃, Me₂SnCl, SnBu₄,
tetraisopropoxystannane, tetrakis(acetyloxy)stannane, Me₃SnCl, Et₃Sn⁺and Me₃Sn⁺; with the anionic counterion of the stannic and stannous cations being a noncoordinating anion selected from BF₄⁻, SbF₆⁻, B(C₆F₅)₄⁻, B(C₆H₅)₄⁻, CF₃SO₃⁻ or TfO⁻ and PF₆⁻, or a halide selected from F⁻, Cl⁻, Br⁻ and I⁻,and
(ii) an organic base selected from triazabicyclodecene (TBD); N-methyltriazabicyclodecene (Me-TBD), 1,8-diazabicyclo[5.4.0]undec-7-ene (DBU), trimethylamine, triethylamine, piperidine, 4-dimethylaminopyridine (DMAP), 1,4-diazabicyclo[2.2.2]octane (DABCO), proline, phenylalanine, a thiazolium salt, N-diisopropylethylamine (DIPEA or DIEA),
and (iii) a halide salt selected from the chloride, bromide, iodide and fluoride salts, said halide salts being selected from NaF, NaCl, NaBr, Nal, KCl, LiCl, [(n-Bu₄)N⁺,F⁻], [(n-Bu₄)N⁺, Cl⁻], [(n-Bu₄)N⁺,Br⁻], [(n-Bu₄)N⁺,I⁻], [PPh₄⁺,F⁻], [PPh₄⁺,Cl⁻], [PPh₄⁺,Br⁻] and [PPh₄⁺,I⁻].

7. The process as claimed in claim 1, additionally using at least one basic additive selected from
organic amines selected from triethylamine, piperidine and 4-dimethylaminopyridine,
ammonia and ammonium,
carbon-containing inorganic bases selected from carbonate salts CO₃²⁻ and hydrogen carbonate salts HCO₃⁻, said carbonate salts CO₃²⁻ and hydrogen carbonate salts HCO3 being selected from CaCO₃ and NaHCO₃,
oxygen-containing inorganic bases selected from the hydroxide salts HO⁻, said hydroxide salts being selected from KOH and NaOH.

8. The process as claimed in claim 1, wherein the amount of basic additive used is from 0.1 to 1 molar equivalent, inclusive, relative to the number of moles of formic acid.

9. The process as claimed in claim 1, wherein production of dihydrogen takes place at a pressure of CO₂, H₂, dinitrogen (N₂), argon or a mixture of at least two of these gases.

10. The process as claimed in claim 1, wherein production of dihydrogen takes place at a pressure between 0.1 and 75 bar.

11. The process as claimed in claim 1, wherein the temperature of the reaction of formic acid with the catalyst is between 15 and 150° C.

12. The process as claimed in claim 1, wherein the duration of the reaction of formic acid with the catalyst optionally in the presence of a basic additive is from 5 minutes to 200 hours,

13. The process as claimed in claim 1, wherein the reaction is carried out in a solvent or a mixture of at least two solvents selected from:
water;
ethanol or ethylene glycol;
diethyl ether, or THF;
benzene, or toluene;
pyridine, or acetonitrile;
dimethylsulfoxide;
chloroform, or methylene chloride;
supercritical CO₂.

14. The process as claimed in claim 1, wherein the amount of catalyst is from 0.0001 to 1 molar equivalent, relative to the number of moles of formic acid.

15. (canceled)

16. A process of producing energy, wherein it comprises a step of producing dihydrogen from formic acid by the process as claimed in claim 1.

17. The process as claimed in claim 10, wherein production of dihydrogen takes place at a pressure between 0.1 and 30 bar.

18. The process as claim in claim 10, wherein production of dihydrogen takes place at a pressure between 0.1 and 10 bar.

19. The process as claimed in claim 11, wherein the temperature of the reaction of formic acid with the catalyst is between 15 and 130° C.

20. The process as claimed in claim 12, wherein the duration of the reaction of formic acid with the catalyst optionally in the presence of a basic additive is from 10 minutes to 48 hours.

21. The process as claimed in claim 14, wherein the amount of catalyst is from 0.001 to 1 molar equivalent, relative to the number of moles of formic acid.

22. The process as claimed in claim 14, wherein the amount of catalyst is from 0.001 to 0.5 molar equivalent, relative to the number of moles of formic acid.
